(19) United States
(12) Patent Application Publication
(10) Pub. No.: US 2003/0159127 A1
(43) Pub. Date: Aug. 21, 2003

(54) Method and apparatus for producing instruction words to trigger functional units in a processor

(76) Inventors: Matthias Weiss, Dresden (DE); Gerhard Fettweis, Dresden (DE)

Correspondence Address: BAKER & BOTTS, 30 ROCKEFELLER PLAZA, NEW YORK, NY, 10112

(21) Appl. No.: 09/750,733

(22) Filed: Dec. 27, 2000

(30) Foreign Application Priority Data
Dec. 30, 1999 (DE) 199 64 028.9

(51) Int. Cl. G06F 9/44; G06F 9/45

(52) U.S. Cl. 717/106; 717/136

(57) ABSTRACT

The invention relates to a method and an apparatus for generating instruction words to trigger functional units in a processor, where a sequence of data-stationary commands occurs, deriving from a sequence of primary instruction words. Here the primary instruction words consist of several instruction word parts. The instruction word parts are each intended to trigger one functional unit.

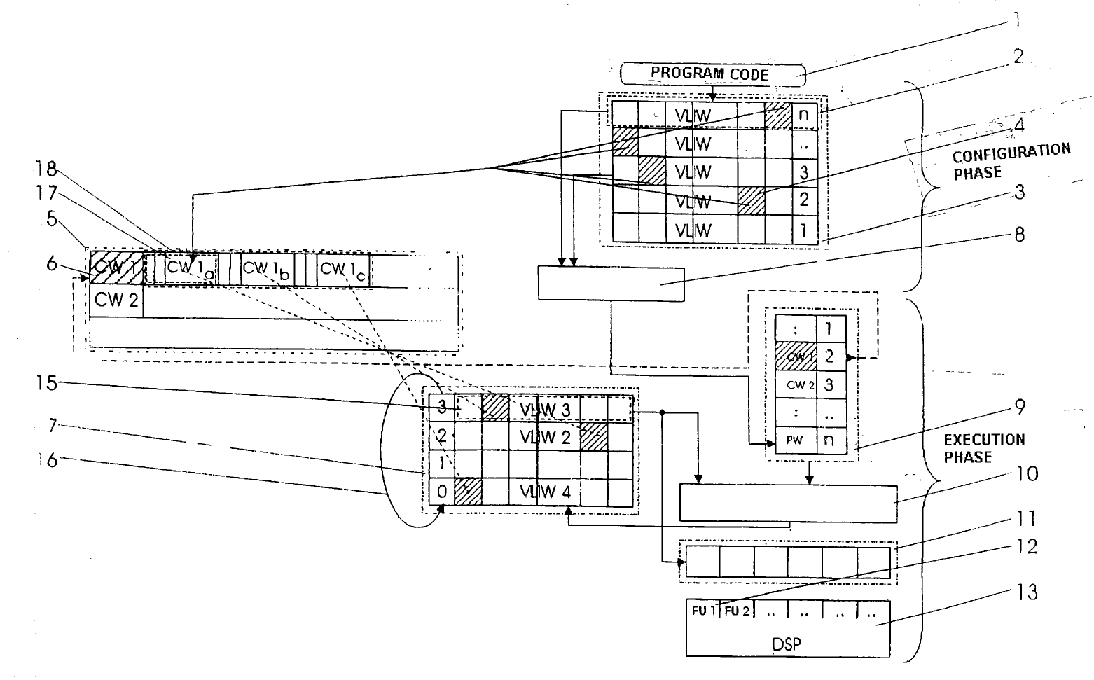

According to the invention, in the working off of the instruction words, a reduction of memory outlay and an enhancement of operating speed are achieved in that the said partial words of a complex are assembled in a complex partial word sequence during a configuration phase and stored in a complex word table. The complex word sequence there deposited is read out, in an execution phase, from the row indicated by a complex word pointer in the complex word table. The complex words contained in it are stored parallelwise by the several assignments internal to the complex words in the corresponding row and column of the secondary instruction word memory, and after output to the corresponding functional units in an instruction word output memory, are able to trigger the required functions.

The invention relates to a method of generating instruction words to trigger functional units in a processor, where, in a configuration phase, a sequence of primary instruction words deriving from a translation of a program code is generated, each primary instruction word consisting of several instruction word parts and each instruction word part is intended to trigger a functional unit, and the instruction word part in one or several primary instruction words serves to execute a data-stationary command, and each primary instruction word undergoes a fractionation into smaller word parts and, in an execution phase, a synthesis of a secondary instruction word corresponding to a primary instruction word is performed out of the smaller word parts. The invention relates further to an apparatus for producing instruction words to trigger functional units in a processor having functional units, having an instruction word memory associated with said functional units, and having an instruction word memory for storing instruction words already generated with a latitude at least equal to the bit latitude of the secondary instruction word, the instruction word buffer consisting of a memory having alternative or fixedly programmed line access.

In German Patent DE 198 59 389 C1, such a method and an apparatus for triggering functional units in a processor are described. By this method and the associated apparatus, while retaining a small program word latitude, the working speed is application-specifically enhanced. To be sure, it has turned out that a further enhancement of the working speed is possible. For some of the commands to be processed are data-stationary. Data-stationary means, in this case, that a command affords no definite information on the point by what route a processor is to execute the command, in particular how many steps are required to carry out the command.

In the execution of a data-stationary command, various steps are carried out in several beats. Each of these steps is carried out by an instruction word part in one instruction word each of a sequence of instruction words, each instruction word part prompting a functional unit to perform a certain action carrying out a partial step of the execution of the command.

Each instruction word, according to the state of the art, must be newly composed over the sequence of program words. Even in the case of like command performances, it is necessary to generate instruction words corresponding to the partial steps of the command and to provide the program words for this purpose. This is necessary also in the case of like commands, that is, for like command sequences, new albeit like program word sequences are required again and again. This entails a large memory outlay and considerable processing time.

It is an object of the invention, then, to reduce the memory outlay and enhance the working speed.

This object is accomplished, on the process side, by the characterizing features of claim 1, and on the apparatus side, by the characterizing feature of claim 3 in combination with the corresponding features of the prior art.

A special conformation of the method according to the invention is set forth in claim 2.

Specifically, the invention makes it possible to describe the processing of the commands of most frequent occurrence, always performed with the same hardware components and always on the same routes, with the corresponding instruction word parts stored in the complex word sequence. When such a command occurs, the contents of the complex word tables may be consulted for command execution. The special treatment of this ever-recurring command as a quite normal (variable) command may be eliminated, thereby relieving the program word memory and enhancing the working speed.

The invention will be illustrated below in more detail with reference to an embodiment by way of example. The corresponding figure of the drawing shows the principle of complex word processing according to the invention.

In the method of triggering functional units 12 in a processor 13 as represented in the figure of the drawing, in accordance with the prior art and hence according to German Patent DE 198 59 389 C1, from a program code 1 by means of a translation in a configuration phase, a sequence of primary instruction words 2 consisting of several instruction word parts 4 is generated. Further, the sequence of primary instruction words 2 is compressed in the program word production 8 and stored as a sequence of corresponding program words in an execution memory 9.

Likewise within the configuration phase, the instruction word parts 4 serving to execute a data-stationary command are assembled in a complex word sequence 18 and stored in a line, indicated by the complex word pointer 6, of the complex word table 5.

In an execution phase, complex word pointers 6 occurring in the execution memory 9 are recognized and, with the index they contain, specify that line of the complex word table 5 to be read out in which the associated complex word sequence 18 was deposited.

The complex word sequence 18 there deposited is read out, and the complex words 17 contained in it are stored parallelwise in the corresponding row and column of the secondary instruction word memory 7 by the several assignments internal to the complex words.

Corresponding to the adjusted secondary instruction word memory sequence 16, firstly the current secondary instruction word 15 is transferred into instruction word output memory 11. Its output triggers the functions required processing at the corresponding functional units 12 of the processor 13.

In the second place, the current secondary instruction word 13 is processed in a secondary instruction word production 10 together with a new program word, so that at its output, an additional secondary instruction word 15 is placed in readiness for storage in the secondary instruction word memory 7.

List of Reference Numerals

| | |
|---|---|
| 1 | program code |
| 2 | primary instruction word |
| 3 | instruction word memory |
| 4 | instruction word part |
| 5 | complex word table |
| 6 | complex word pointer |
| 7 | secondary instruction word memory |
| 8 | program word production |
| 9 | execution memory |
| 10 | secondary instruction word production |
| 11 | instruction word output memory |
| 12 | functional unit |
| 13 | processor |
| 15 [sic] | secondary instruction word |
| 16 | secondary instruction word storage sequence |
| 17 | complex word |
| 18 | complex word sequence |

1. Method of generating instruction words to trigger functional units in a processor, where in a configuration phase, a sequence of primary instruction words deriving from a translation of a program code is produced, each primary instruction word consisting of several instruction word parts and each instruction word part being intended to trigger a functional unit, and the instruction word parts in one or several primary instruction words serving to perform a data-stationary command, and each primary instruction word undergoing a fractionation into smaller word parts and, in an execution phase, a synthesis of a secondary instruction word corresponding to a primary instruction word is performed out of the smaller word parts, characterized in that each of the instruction word parts (4) serving to execute the data-stationary command being assembled as complex words (17) in a complex word sequence (18) and in a row of a complex word table (5) indicated by a complex word pointer (6), in that upon synthesis of secondary instruction words (15) that is to contain a sequence of instruction word parts (4) pertaining to the execution of the data-stationary command in an execution memory (9) the occurring associated complex word pointer (6) is recognized, in that in the row indicated by the complex word pointer (6) in the complex word table (5), the complex word sequence there deposited (18) is read out, in that the complex words (17) contained in it are stored parallelwise in dependence on the current secondary word in the corresponding row and column of the secondary instruction word memory (7) by the several assignments internal to the complex words, in that corresponding to an elective secondary instruction word memory sequence (16) firstly the current secondary instruction word (15) arrives by way of an instruction word output (11) at the corresponding functional unit (12) of the processor (13) for processing, and secondly, it is processed in a secondary instruction word production (10) which at its output places in readiness an additional secondary instruction word (15) to be stored in the secondary instruction word memory (7).

2. Method according to claim 1, characterized in that a fixedly programmed secondary instruction word memory sequence (16) is established.

3. Apparatus for generating instruction words to trigger functional units in a processor having functional units, having an instruction word memory associated with said functional units, and having an instruction word memory for storage of instruction words already generated, having a latitude at least equal to the bit latitude of the secondary instruction word, the instruction word buffer consisting of a memory with elective or fixedly programmed row access, characterized in that the secondary instruction word memory (7) is associated with a read-only or write-and-read complex word table (5) in the form of a matrix register file.
